(19) United States
(12) Patent Application Publication
(10) Pub. No.: US 2005/0168932 A1
(43) Pub. Date: Aug. 4, 2005

(54) Computer component retention module

(76) Inventors: David Arthur Selvidge, Houston, TX (US); David Paquin, Houston, TX (US)

Correspondence Address: HEWLETT-PACKARD COMPANY;Intellectual Property Administration, P.O. Box 272400, Fort Collins, CO, 80527-2400, US

(21) Appl. No.: 10/767,688

(22) Filed: Jan. 29, 2004

(51) Int. Cl. G06F 1/16

(52) U.S. Cl. 361/685

(57) ABSTRACT

By way of example, an embodiment of the present invention comprises an apparatus for use with a computer device. The apparatus includes a first portion configured to support a media device such that the media device is located on a first side of the first portion. The apparatus also includes a second portion located on a second side of the first portion and configured to at least partially secure the position of at least one computer component with respect to a connector coupled to the chassis.

### BACKGROUND

The present invention relates to methods and apparatus for securing computer components in a computer device.

Typical computer devices include a number of components assigned to accomplish various tasks. As one example, computer devices generally include one or more processor assemblies that interact with electrical connectors located in the computer device. To ensure a secure connection between the processor assembly and the corresponding electrical connector, many computer devices employ processor-cages. Traditionally, a processor-cage is a box-like structure that fits over the processor assembly, thereby securing the engagement between the processor and its corresponding electrical connector. To access the processor assembly for repair and/or replacement, the processor-cage must be uncoupled from the computer device. Because of this need for accessibility, the region of the computer device located above the processor assembly is generally unused. Therefore, other components of the computer device, such as cooling fans and media devices, are not typically located above the processor assembly and processor-cage.

The optimization of utilizable space generally factors into the design of computer devices. Additionally, industry standards may dictate the dimensions of computer device designs. For example, in a rack system, a rack mountable computer device may be limited to a height of 2U, which is approximately 3.5 inches (≈8.9 cm), as one “U” equals 1.75 inches. Unfortunately, the reservation of regions adjacent the processor and other components for accessibility may increase the overall dimensions of the computer device's design.

Cooling is also important in many computer devices, particularly those with compact enclosures and close assembly of components. For example, side-by-side placement of the various computer components may reduce the efficacy of the cooling features of computer device. Moreover, cooling airflows may become less effective with increased dispersion and lack of focus on the heat producing components.

### BRIEF DESCRIPTION OF THE DRAWINGS

FIG. 1 illustrates a perspective view of an exemplary rack mounted computer system having a plurality of computer devices, in accordance with aspects of the present invention;

FIG. 2 illustrates a diagrammatical representation of an exemplary computer device in accordance with aspects of the present invention;

FIG. 3 illustrates an exemplary computer device in an open configuration, in accordance with aspects of the present invention;

FIG. 4 illustrates the exemplary computer device of FIG. 3 in a closed configuration, in accordance with aspects of the present invention; and

FIG. 5 illustrates a partial and cross-sectional view of the computer device of FIG. 4 along line 5-5, in accordance with aspects of the present invention.

### DETAILED DESCRIPTION OF SPECIFIC EMBODIMENTS

As discussed below, certain embodiments of the present invention comprise an apparatus for securing components in a computer device. The exemplary apparatus includes a first portion configured to support at least one computer component, such as a floppy drive or a compact disk (CD) drive. The exemplary apparatus also includes a second portion that at least partially maintains the position of a second computer component with respect to the computer device. For example, the second portion may maintain the position of a processor assembly with respect to a chassis of the computer device. Advantageously, the exemplary apparatus provides a mechanism by which the region of the computer device located above the second computer component becomes viable for placement of a number of computer components, thereby improving the utilization of space within computer device.

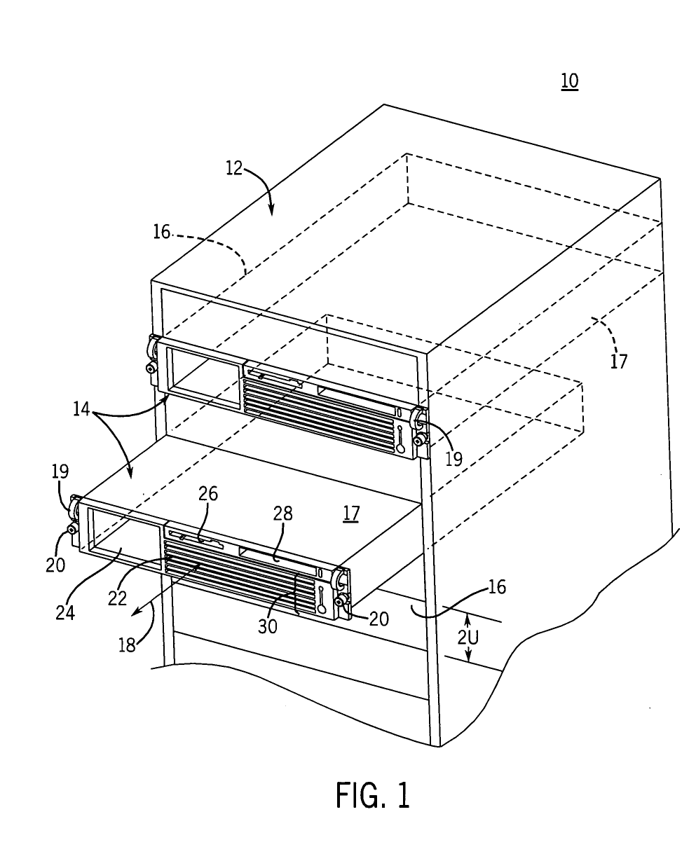

Turning to the figures, FIG. 1 illustrates a portion of an exemplary rack mounted computer system, generally referenced by numeral 10. By way of example, rack mounted computer systems 10 may provide relatively large amounts of processing power for use in Internet, intranet, and multitasking applications, among others. However, it should be noted that the disclosed embodiments are equally applicable to non-rack mounted systems, such as desktop computers and portable computers. The exemplary rack mounted computer system 10 includes a protective rack 12 that houses one or more computer devices 14 within individual bays 16 of the rack 12. As discussed further below, each computer device 12 includes a chassis 17 that secures and houses various components of the computer device 14.

In the exemplary rack 12, each bay 16 presents an industry standard 2U profile and, as such, may receive conforming computer devices 14 having heights of approximately 2U. As appreciated by those of ordinary skill in the art, 2U computer devices 14 and bays 16 present a height of approximately 3.5 inches (≈8.9 cm), as one “U” equals 1.75 inches. Of course, other rack profiles, such as 1U and non-standard designs, may benefit from the present invention as well. Advantageously, the exemplary rack 12 provides an enclosure that further protects the computer device 14, particularly the sensitive components of the computer device 14, from inadvertent damage. Moreover, the rack 12 facilitates assembly of a plurality of computer devices 14 in an organized and transportable manner.

From time to time, the computer device 14 may require servicing or replacement. Accordingly, to facilitate access to the various components of the computer device 14 and to the computer device 14 itself, a pair of telescoping rails (not shown) may secure the computer device 14 to the rack 12. These telescoping rails may permit inward and outward movement of the computer device 14 with respect to the rack 12, as represented by bi-directional arrow 18. Advantageously, handles 19 located on the computer device 14 may assist a technician and/or operator in displacing the computer device 14 with respect to the rack 12. However, the computer device 14 may also include fasteners 20, such as the illustrated screws, to secure the computer device 14 within the rack 12 and prevent inadvertent movement of the computer device 14 during operation.

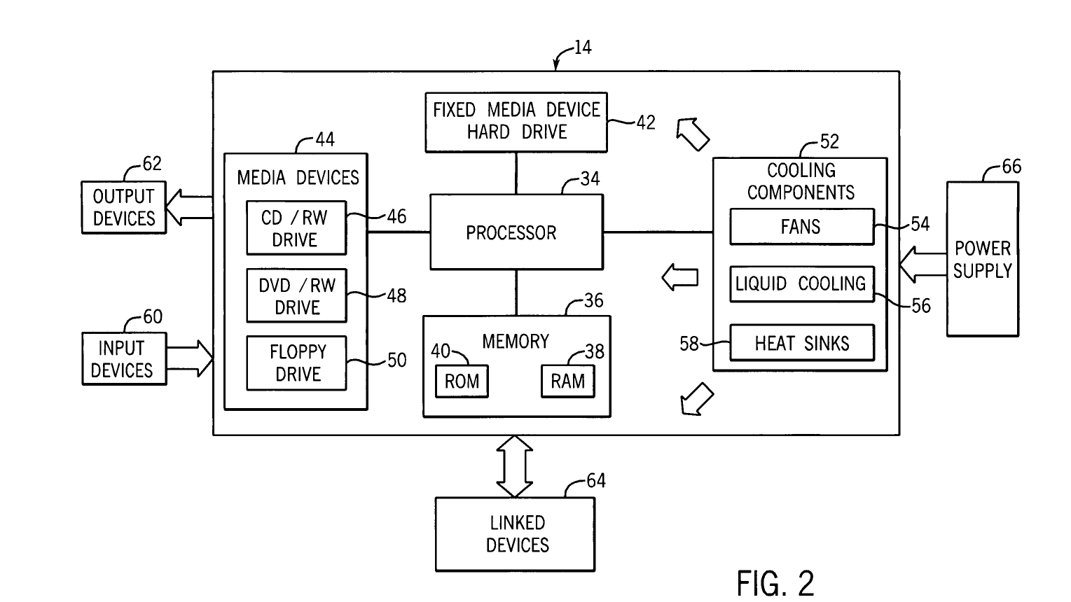

The computer device 14 may also include a bezel 22 that contains a number of features advantageous to the operation of the computer device 14, as discussed further below. For example, the bezel 22 may include a hard disk-drive aperture 24 for receiving a hard disk drive 42 (see FIG. 2). Additionally, the bezel 22 may include media device apertures, such as a floppy disk drive aperture 26 and a compact disk (CD) drive aperture 28 to facilitate the insertion of appropriate media disks into the computer device 14. Furthermore, the bezel 22 may include a louvered section 30 that facilitates airflow through the computer device 14. The bezel 22 may comprise a single contiguous unit or may comprise an assembly of parts.

FIG. 2 illustrates an exemplary computer device 14 in diagrammatical form. The computer device 14 includes a processor 34, such as a microprocessor, that controls many of the functions and operations of the computer device 14. By way of example, the processor 34 may operate under the direction of software programming, such as an operating system. Therefore, the software programming may coordinate operations of the processor 34 and other components of the computer device 14. The computer device 14 may also include memory components 36, such as random access memory (RAM) components 38 and read only memory (ROM) components 40, which may store software programming to facilitate execution of the software programming.

The exemplary computer device 14 also includes media devices, such as fixed media devices 42 or portable media devices 44, that store data for use by the computer device 14 and/or the rack computer system 10 (see FIG. 1). By way of example, a fixed media device 42 may comprise a hard disk drive that includes one or more hard disks that are generally dedicated to the computer device 14. By contrast, portable media devices 44 may receive media that are not dedicated to a particular computer device 14. Portable media devices 44 may comprise a compact disk read and/or write (CD/RW) drive 46, a digital video disk read and/or write (DVD/RW) drive 48, and/or a floppy disk drive 50, among others. Advantageously, the portable media devices 14 may include “hot-pluggable” features, which facilitate coupling and/or uncoupling of the media device 14 with respect to an operating computer device 14.

During operation, various components of the computer device 14 may generate heat. Accordingly, the computer device 14 may include cooling components 52, such as fans 54, a liquid cooling system 56, and heat sinks 58, to remove heat and improve performance. For example, such cooling components 52 may increase the efficacy of convective cooling within the computer device 14, as discussed further below.

The computer device 14 may permit interaction with a user and/or technician via input devices 60 and output devices 62. For example, input devices may include buttons, switches, a keyboard, a light pen, a mouse, and/or a voice recognition system, all of which allow the user and/or technician to provide commands and input instructions to the computer device 14. Output devices 62, by way of example, may include a liquid crystal display (LCD), a cathode-ray tube (CRT), a series of light emitting diodes (LEDs), and/or an audio display, among others.

The computer device 14 may also communicate and interact with other devices that are appropriately linked, i.e., linked devices 64. For example, the computer device 14 may interact with other computer devices 14 that are disposed within one or more racks 12 (see FIG. 1). As another example, the computer device 14 may interact and communicate with others devices via a network, such as a wide area network (WAN), a local area network (LAN), and the Internet, among others.

To operate, the computer device 14 may receive power from a power supply 66. By way of example, the computer device 14 may receive power from an AC power source, such as an AC adapter plugged into a wall outlet. Advantageously, the AC adapter may rectify the AC power to an appropriate DC power for use by the components of the computer device 14. Alternatively, if the computer device 14 is portable, the power supply 66 may include permanent batteries, portable batteries, and/or rechargeable batteries. Moreover, the power supply 66 may also include a DC adapter for plugging into a vehicle's cigarette lighter, for instance.

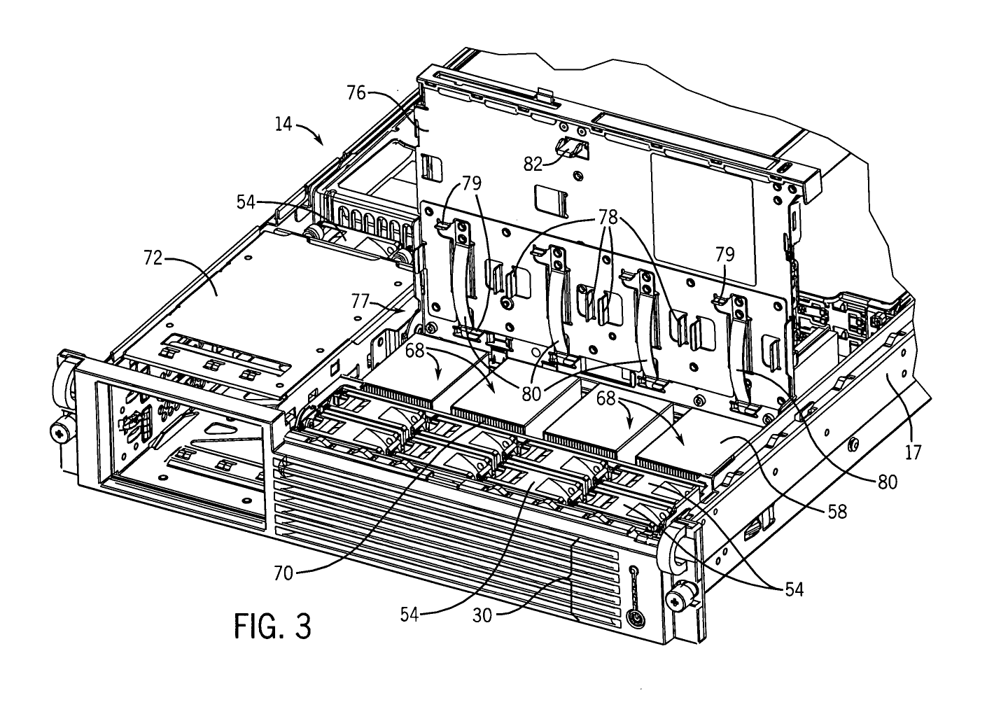

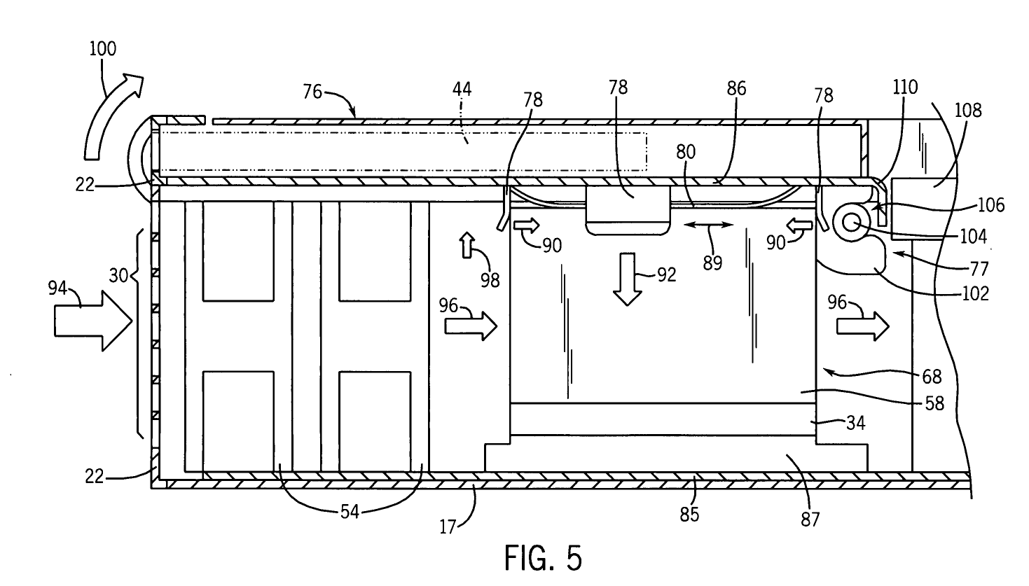

FIG. 3 illustrates a portion of an exemplary computer device 14 in an open or accessible configuration. Particularly, FIG. 3 provides a view of various computer components of the computer device 14. For example, the exemplary computer device 14 includes four processor assemblies 68. As discussed further below, each processor assembly 68 comprises a heat sink 58 secured to a processor 34 (see FIG. 5). Advantageously, the heat sink 58 may secure with the processor 12, such that the processor 34 and the heat sink 58 form a mated assembly. By way of example, an adhesive may bond the heat sink 58 to the processor 34, such that the processor 34 and heat sink 58 act as a single, contiguous unit.

The computer device 14 may also include a plurality of cooling fans 54 located between the bezel 22 and the processor assemblies 68. These cooling fans 54 draw air in through the louvered section 30 of the bezel 22 and generate airflow across the processor assemblies 68. Advantageously, this generated airflow increases the efficacy of convective cooling across fins 70 of the heat sinks 58. Additionally, cooling fans 54 located proximate to other heat generating components of the computer device 14 may generate convectively cooling airflow that is focused on particular heat generating computer components. For example, a cooling fan 54 located adjacent to a hard drive cage 72, which is configured to support a hard disk drive 42 (see FIG. 2), may focus airflow to cool the hard disk drive more effectively. Advantageously, the cooling fans 54 may include “hot-pluggable” features that facilitate the coupling and/or uncoupling of the cooling fans 54 with respect to an operating computer device 14.

The exemplary computer device 14 also includes a computer component support structure pivotably coupled to the chassis 17, such as the illustrated media tray 76. FIG. 3 illustrates the media tray 76 in an open configuration with respect to the chassis 17 of the computer device 14. On nonadjacent sides of the media tray 76, pivot assemblies 77 pivotably couple the media tray 76 to the hard drive cage 72 and a side wall 80 of the chassis 17, respectively. Thus, the media tray 76 may be pivoted about the pivot assemblies 77 to facilitate access to the computer components located below the media tray 76 in the computer device 14, as discussed further below. However, other embodiments of the media tray 76 may comprise other mounting mechanisms, such as telescoping rails or snap-fit assemblies.

The exemplary media tray 76 provides a support substrate for securing the media devices 44 and 46 (see FIG. 2), because the media tray 76 may comprise a flat, plate-like surface onto which the media devices may fasten. By way of example, the media tray 76 may support portable media devices (e.g., a CD/RW drive 46, a DVD/RW drive 48, and/or a floppy drive 50) and fixed media devices (e.g., a hard disk drive). With respect to the media tray 76, the media devices 42 and 44 are located above the processor assemblies 68 within the chassis 17 of the computer device 14, as discussed further below. This stacked arrangement may provide a better utilization of space within the computer device 14 by allowing for a greater number of computer components to be disposed within the limited space of the chassis 17.

The exemplary media tray 76 also includes a number of features that at least partially secure various components of the computer device 14 with respect to the chassis 17, as discussed further below. For example, the media tray 76 may include retention tabs 78 and 79 that extend from the media tray 76 and that interact with each of the processor assemblies 68 to maintain the position of the respective processor assemblies 68 with respect to the chassis 17 of the computer device 14. Additionally, the media tray 76 may include one or more resilient members, such as the illustrated leaf springs 80, that provide securing forces to components of the computer device 14. For example, each of the four illustrated leaf springs 80 may provide securing forces to secure engagement of a corresponding processor assembly 68 with respect to electrical connectors in the computer device 14, as discussed further below. Advantageously, the media tray 76 may include a latch assembly 82 that secures the media tray 76 in a closed configuration with respect to the chassis 17. For example, the latch assembly 82 may interact with the chassis 17 and/or the bezel 22 to prevent pivotal movement of the media tray 76 from the closed configuration. However, by actuating the latch 82, an operator and/or technician may release the media tray 76 for pivotal movement to the open configuration, as discussed further below.

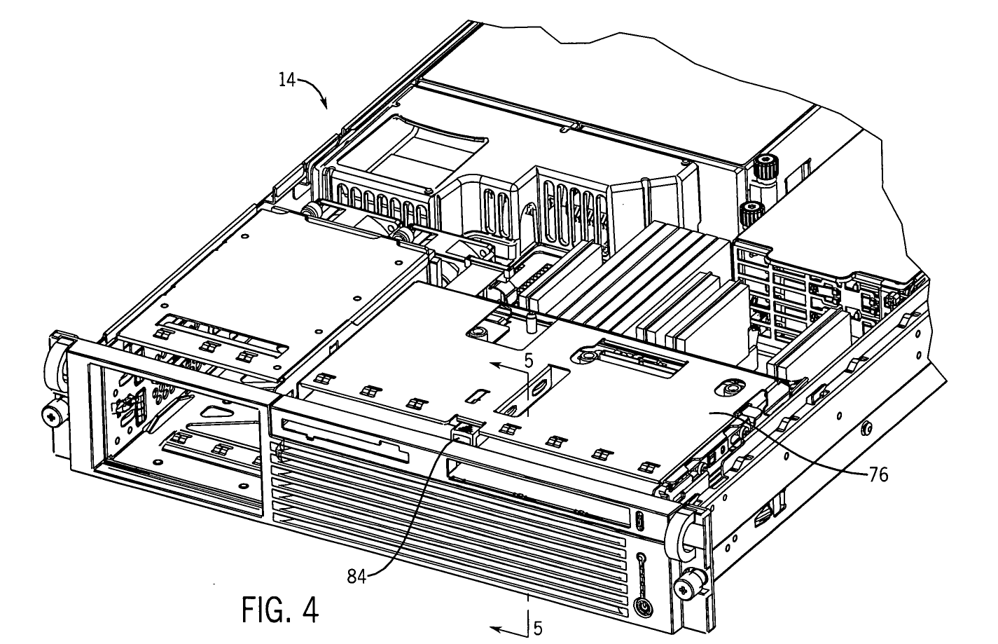

FIG. 4 illustrates a portion of the exemplary computer device 14 in a closed configuration. As illustrated, the media tray 76 resides directly above the processor assemblies 68 and the bank of cooling fans 54 (see FIG. 3). Accordingly, the media devices 42 and 44 (see FIGS. 2 and 3) that are supported by the media tray 76 also reside above the processor assemblies 68 and the cooling fans 54. Thus, the space above the processor assemblies 68 provides a utilizable region in the computer device 14 for disposing computer components. Additionally, by pivoting the media tray 76 to the open configuration (see FIG. 3), the processor assemblies 68 and the cooling fans 54 located beneath the media tray 76 are easily accessible for repair and/or replacement. Advantageously, the media tray 76 may include an operator 84 configured to actuate the latch 82 to release the media tray 76 with respect to the chassis 17 facilitating pivotal movement of the tray 76.

FIG. 5 illustrates a partial cross-sectional view of the computer device 14 of FIG. 4 along line 5-5. As illustrated, the media tray 76 is disposed in a closed configuration with respect to the chassis 17. To ease explanation, it should be noted that FIG. 5 does not illustrate a number of components of the computer device 14 that are not germane to the instant discussion. FIG. 5, however, does illustrate a number of additional components of the computer device 14 not present in the previous figures. For example, the exemplary computer device 14 includes a printed circuit board (PCB) 85 configured to provide electrical connections and pathways for the various components of the computer device 14, as appreciated by those of ordinary skill in the art. That is to say, one or more PCBs 85 may facilitate the electrical interconnections between various components of the computer device 14 (see FIG. 2). The exemplary computer device 14 also includes an electrical connector, such as the illustrated interposer 87, for coupling various computer components to the PCB 85. By way of example, the interposer 87 may include sockets configured to receive pins located on the underside of the processor 34. Accordingly, by inserting the pins of the processor 34 into the sockets of interposer 87, the processor 34 may electrically and mechanically couple with the PCB 85 and with the computer device 14.

With respect to the orientation of FIG. 5, the media tray 76 supports the media device 44 above a base portion 86 of the media tray 76. The media device 44 may electrically couple to the PCB 85 via a flexible connection cable, such as a ribbon cable. However, the exemplary computer device 14 also includes components that are disposed below the base portion of media tray 76. For example, the cooling fans 54 and the processor assembly 68 are located underneath the base portion 86 of the media tray 76. Accordingly, the exemplary media tray 76 facilitates the utilization of a region of the computer device located above the processor assembly 68, the PCB 85, and the cooling fans 64. Advantageously, such stacked positioning facilitates the assembly of more computer components in a limited space of the chassis 17, thereby facilitating the inclusion of more features in the computer device 14, for example.

As discussed above, the media tray 76 may include features that assist in securing the computer components located below the media tray 76 with respect to the chassis and/or electrical connectors. For example, the retention tabs 78 may interact with the heat sink 58 of the processor assembly 68 to prevent horizontal movement of the processor assembly 68, as indicated by the bi-directional arrow 89. Advantageously, the tabs 78 may prevent or hinder horizontal movement of the processor assembly 68 due to shock and/or inadvertent movement. Advantageously, the media tray 76 may include one or more pairs of retention tabs 78 and 79 that resiliently interact with nonadjacent sides of the processor assembly to produce laterally securing forces that restrict movement of the processor assembly 68, as indicated by arrows 90. These forces 90 prevent inadvertent disengagement of the processor 34 and processor assembly 68 from the interposer 87.

Additionally, each illustrated leaf spring 80 may bias the corresponding processor assembly 68 into engagement with its respective interposer 87. In the illustrated closed configuration, the leaf spring 80 provides a downwardly directed securing force that biases the processor assembly 68 towards the interposer 87, as represented by arrow 92. This force 92 secures the engagement between the interposer 87 and the processor 34 and the processor assembly 68. Although the foregoing discussion relates to the securing of a processor 34 and a processor assembly 68 to an interposer 87, the tabs 78 and the leaf spring 80 may be similarly configured to secure other computer components (e.g., cooling fans 54) of the computing device 14.

Additionally, the media tray 76 may direct airflow generated by the cooling fans 54 across the processor assembly 68. For example, the cooling fans 54 may draw in air through the louvered section 30 of the bezel 22, as represented by arrow 94. The cooling fans 54 then focus airflow through the processor assembly 68, as represented by arrows 96. In the exemplary computer device 14, the base portion 86 of the media tray 76 and the chassis 17 cooperatively define an airflow channel. Moreover, as airflow meets the solid face of the processor assembly 68, airflow is at least partially directed upward, as represented by arrow 98. However, as upwardly traveling airflow 98 meets the relatively solid profile of the media tray 76, airflow is at least partially directed back toward the processor assembly 68, as indicated by the direction of arrow 96. Accordingly, a substantial amount of airflow generated by the cooling fans 54 travels across or through the processor assembly 68, thereby increasing the efficacy of the convective cooling within computer device 14.

As stated above, the computer components located beneath the media tray 76 (e.g., the cooling fans 54 and the processor assembly 68) may benefit from maintenance and/or replacement from time-to-time. Accordingly, with the computer withdrawn from the rack 12, an operator and/or technician may pivot the media tray 76 upwardly (as represented by directional arrow 100) into an open configuration (see FIG. 3) to access the appropriate computer components. To facilitate pivotal movement of the media tray 76, the pivot assemblies 77 of the computer device 14 may include pivot flanges 102 located on non-adjacent sides of the media tray 76 that interact with corresponding pivot stems 104 that extend from the chassis 17 and the hard drive cage 72 (see FIG. 3) respectively. Advantageously, the pivot flange 102 may include a notched region 106 that facilitates uncoupling of the media tray 76 from the chassis 17 and the computer device 14. By uncoupling the media tray 76, the media device 44 may be replaced at a remote location without bringing the computer device 14 off-line. Furthermore, the computer device 14 may include a support tab 108 that interacts with an arcuate portion 110 of the media tray 76 to support the media tray in the open configuration (see FIG. 3) during maintenance. Moreover, the close tolerance between the support tab 108 and the arcuate portion 110 may generate sufficient friction and interference to retain the media tray 76 in the open configuration until a biasing force is applied downwardly onto the media tray 76.

1. An apparatus for use with a computer device having a connector coupled to a chassis, comprising:
a first portion configured to support at least one media device such that the at least one media device is located on a first side of the first portion; and
a second portion located on a second side of the first portion and configured to at least partially secure the position of at least one computer component with respect to the connector.

2. The apparatus as recited in claim 1, wherein the first portion comprises a releasable mounting mechanism configured to move the first portion between open and closed positions relative to the chassis.

3. The apparatus as recited in claim 1, wherein the second portion includes a resilient member configured to bias the at least one computer component into an engaged configuration with respect to the connector.

4. The apparatus as recited in claim 3, wherein the resilient member comprises a leaf spring.

5. The apparatus as recited in claim 1, wherein the second portion has a plurality of tabs interactable with non-adjacent sides of the at least one computer component.

6. The apparatus as recited in claim 1, comprising a flange portion extending from the first portion and having at least one aperture for receiving a media disk therethrough.

7. The apparatus as recited in claim 1, comprising a latch mechanism configured to secure the first portion releasably in a closed configuration with respect to the chassis.

8. The apparatus as recited in claim 1, comprising a pivot assembly configured to couple the first portion pivotably with respect to the chassis.

9. A computer device, comprising:
a chassis comprising a first support configured to support a first computer component; and
a structure selectively positionable between open and closed configurations with respect to the chassis, wherein the structure comprises a second support configured to support a second computer component and a third support to at least partially retain the first computer component with respect to the chassis in the closed configuration.

10. The computer device as recited in claim 9, wherein the first and second supports are configured to position the first and second computer components on opposite sides of the structure.

11. The computer device as recited in claim 9, wherein the third support comprises a resilient member configured to bias the first computer component into a connected configuration with respect to the chassis.

12. The computer device as recited in claim 9, comprising at least one cooling device configured to cool the first computer component.

13. The computer device as recited in claim 12, wherein the cooling component comprises a fan configured to produce airflow across the first computer component, wherein the first computer component includes a processor supported by the first support.

14. The computer device as recited in claim 13, wherein the structure is configured to at least partially direct airflow across the first computer component.

15. The computer device as recited in claim 9, comprising the second computer component, which comprises a media device.

16. The computer device as recited in claim 15, wherein the media device comprises a disk drive.

17. The computer device as recited in claim 9, wherein the structure is removably coupled to the chassis.

18. The computer device as recited in claim 9, comprising the first computer component, which includes a heat sink coupled to a processor.

19. The computer device as recited in claim 9, wherein the structure is pivotable with respect to the chassis.

20. The computer device as recited in claim 9, comprising a positioning tab coupled to the chassis and configured to support the structure in an open configuration with respect to the chassis.

21. The computer device as recited in claim 9, comprising the first computer component, which comprises a hot-pluggable device.

22. A computer system, comprising:
a rack; and
at least one computer device located in the rack, the computer device comprising:
a chassis;
a processor assembly coupled to the chassis; and
a structure positionably coupled to chassis, wherein the structure is configured to at least partially maintain the position of the processor assembly with respect to the chassis and to support at least one media device.

23. The computer system as recited in claim 22, wherein the computer device has a 2U thickness.

24. The computer system as recited in claim 22, wherein the structure is pivotably coupled to the chassis.

25. The computer system as recited in claim 22, wherein the computer device comprises a plurality of processor assemblies.

26. A method for use with a computer device having a chassis, comprising:
supporting a first computer component on a first side of a structure positionably coupleable to the chassis; and
restricting movement of a second computer component on a second side of the structure with respect to the chassis.

27. The method as recited in claim 26, comprising biasing the second computer component into an engaged configuration with respect to a connector via a resilient member coupled to the second side of the structure.

28. The method as recited in claim 26, comprising directing airflow across the second computer component via the structure.

29. The method as recited in claim 26, comprising pivotably coupling the structure to the chassis.

30. The method as recited in claim 26, comprising removably coupling the structure to the chassis.

31. A computer device, comprising:
means for supporting a first computer component on a first side of a structure positionably coupleable to a chassis; and
means for restricting movement of a second computer component on a second side of the structure with respect to the chassis.

32. The computer device as recited in claim 31, comprising means for positionably securing the structure to the chassis between open and closed configurations.

33. A media tray for use with a computer device, comprising:
a plate-like portion configured to support at least one media device on a first side of the plate-like portion; and
a second portion located on a second side of the plate-like portion opposite the first side and configured to at least partially secure the position of a processor assembly with respect to an electrical connector.

34. The media tray as recited in claim 33, wherein the electrical connector comprises an interposer.

35. The media tray as recited in claim 33, comprising a pivot assembly configured to facilitate pivotal movement of the plate-like portion and second portion with respect to a chassis of the computer device.

36. The media tray as recited in claim 33, wherein the second portion comprises a leaf spring.

37. The media tray as recited in claim 36, wherein the second portion comprises at least one pair of tabs configured to engage with non-adjacent sides of the processor assembly.
